(19) United States
(12) Patent Application Publication
(10) Pub. No.: US 2021/0303470 A1
(43) Pub. Date: Sep. 30, 2021

(54) SEQUENTIAL PREFETCHING THROUGH A LINKING ARRAY

(71) Applicant: Micron Technology, Inc., Boise, ID (US)

(72) Inventors: Scheheresade Virani, Frisco, TX (US); Aleksei Vlasov, Austin, TX (US); Mark Ish, San Ramon, CA (US)

(21) Appl. No.: 16/833,306

(22) Filed: Mar. 27, 2020

(51) Int. Cl. G06F 12/0853; G06F 12/123; G06F 9/50; G06F 11/30

(52) U.S. Cl. CPC G06F 12/0853; G06F 11/3037; G06F 9/5016; G06F 12/123

(57) ABSTRACT

Methods, systems, and devices for sequential prefetching through a linking array are described. A prefetch manager can detect that a set of tags occupying a queue of a memory sub-system corresponds to a single read descriptor indicating a sequential read pattern. The prefetch manager can determine that a number of the set of tags occupying the queue is below a queue threshold and store data associated with at least one tag of the set of tags in an internal performance memory of the memory sub-system based on the detecting and the determining. In such cases, the prefetch manager can prefetch data from a memory manager and store in the internal performance memory.

### TECHNICAL FIELD

The following relates generally to a memory sub-system and more specifically to sequential prefetching through a linking array for a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 is an example of a computing system that includes a memory sub-system in accordance with some embodiments of the present disclosure.

FIG. 2 is a flow diagram of an example method to sequential prefetching through a linking array in accordance with some embodiments of the present disclosure.

FIG. 3 is a block diagram of an example system that supports sequential prefetching through a linking array in accordance with some embodiments of the present disclosure.

FIG. 4 is an example of a computer system in which embodiments of the present disclosure can operate.

### DETAILED DESCRIPTION

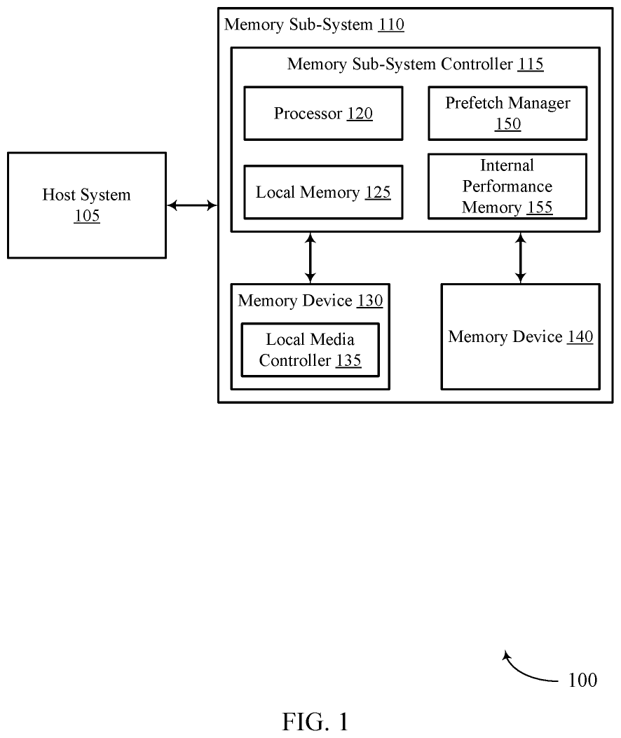

Aspects of the present disclosure are directed to sequential prefetching through a linking array. A memory sub-system can be a storage device, a memory module, or a hybrid of a storage device and memory module. Examples of storage devices and memory modules are described below in conjunction with FIG. 1. In general, a host system can utilize a memory sub-system that includes one or more memory components (also hereinafter referred to as “memory devices”). The host system can provide data to be stored at the memory sub-system and can request data to be retrieved from the memory sub-system.

A memory device can be a non-volatile memory device. A non-volatile memory device is a package of one or more dice. Each die can consist of one or more planes. For some types of non-volatile memory devices (e.g., negative-and (NAND) devices), each plane consists of a set of physical transfer units, for example, blocks. Each block consists of a set of pages. Each page consists of a set of memory cells, which store bits of data.

Data operations can be performed by the memory sub-system. The data operations can be host-initiated operations. For example, the host system can initiate a data operation (write, read, erase, etc.) on a memory sub-system. The host system can send access requests (e.g., write command, read command) to the memory sub-system, such as to store data on a memory device at the memory sub-system and to read data from the memory device on the memory sub-system.

A memory sub-system can utilize tags (e.g., SysTags) where the tags contain information about a logical block address (LBA), a translation unit address (TUA), an internal buffer addresses, and an HTag. The TUA can describe user data from the host system perspective, and the internal buffer address can track the location of the data in the transmission process. The HTag can be a command applied to the LBA(s) included in the tag. The tags (e.g., SysTags) can be individual entities that cannot pass information about other tags. For example, a tag can be an internal data description and control block that can be used to pass user data information and the data itself between the various hardware and firmware components.

In some embodiments, tags can be linked through the use of a “next SysTag” pointer included within each tag, thereby grouping tags together to work through commands. The linking of tags can allow a tag to point to another (e.g., next) tag. In some systems, individual tags can be placed into a queue within the memory sub-system and processed individually. Through the linkage, multiple tags can be processed with a single command as one tag can link (e.g., point) to another tag. In such systems, however, the linking of tags can be underutilized, which can result in the memory sub-system experiencing a performance loss, increased signaling overhead, and increased processing overhead for performing operations. In such cases, underutilizing the linking of tags can decrease performance of the memory sub-system, increasing power consumption, or the like.

Aspects of the present disclosure address the above and other deficiencies by having a memory sub-system that sequentially prefetches data. In a low queue depth workload, the number of tags allocated for host commands can be low. In some examples, when a sequential read pattern is recognized (i.e., when a single descriptor, such as a single read descriptor, is generated for multiple tags), the memory sub-system can prefetch (i.e., read) the data from NAND and store it in static random access memory (SRAM). In such cases, when the tags are processed, the memory manager (e.g., backend) procedures already have been performed (e.g., the data from NAND has been read (i.e., prefetched) prior to the processing of the tag corresponding to the data) and the read data can be accessible via the SRAM. For example, the data can be transferred to the host system when a host command is processed for targeted prefetched data. Because the prefetched data can be stored in SRAM, the host system can access the prefetched data more quickly than the backend procedures used for reading data from NAND each time a command is issued. Such techniques increase the performance of the memory sub-system experiencing improved read speeds, reduced power consumption, decreased processing complexity, and improved processing times.

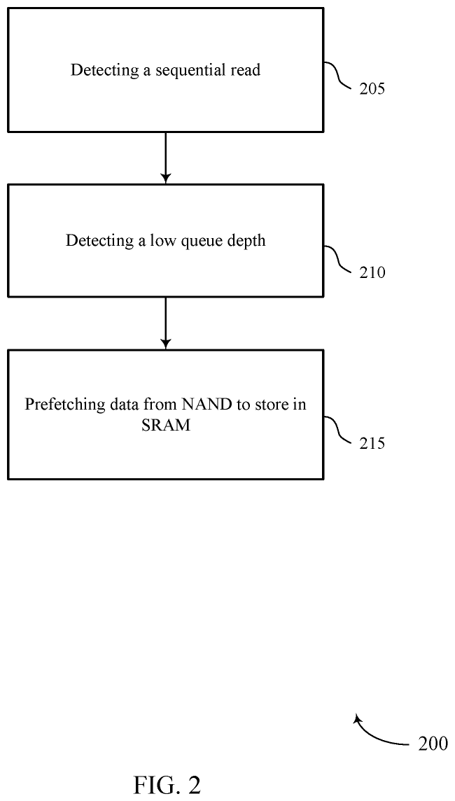

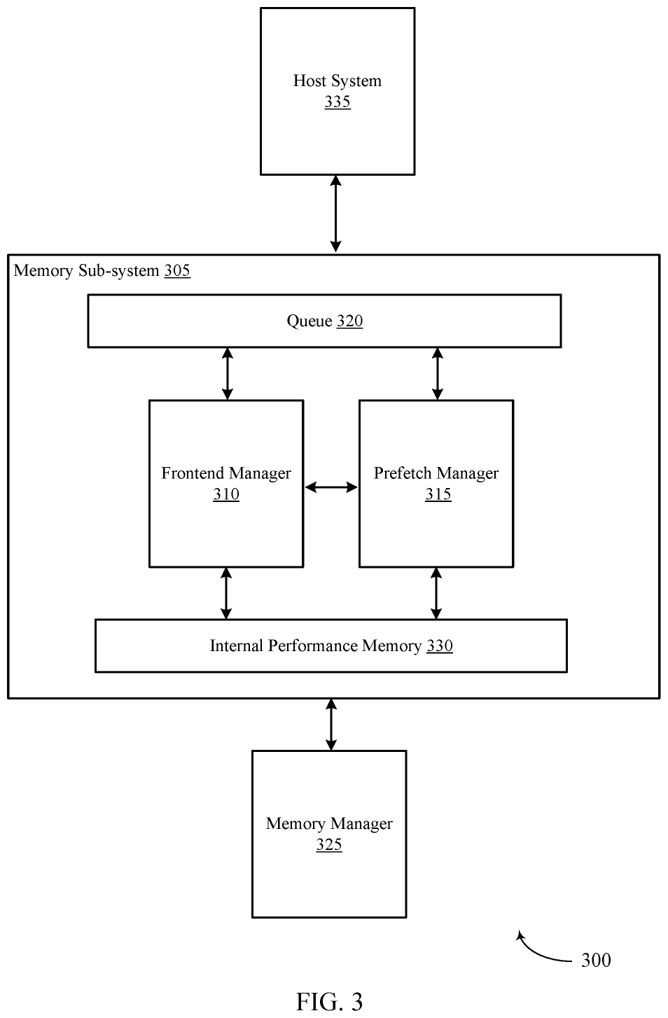

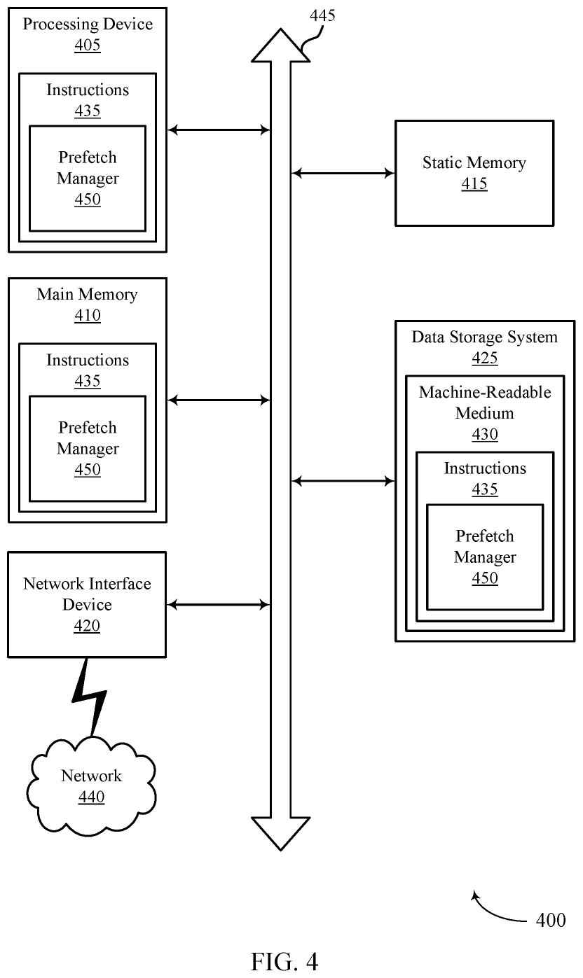

Features of the disclosure are initially described in the context of a computing environment as described with reference to FIG. 1. Features of the disclosure are described in the context of method and block diagrams as described with reference to FIGS. 2 and 3. These and other features of the disclosure are further illustrated by and described with reference to a computer system that relates to sequential prefetching through a linking array as described with reference to FIG. 4.

FIG. 1 is an example of a computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, a secure digital (SD) card, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and various types of non-volatile DIMM (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 105 that is coupled with one or more memory sub-systems 110. In some embodiments, the host system 105 is coupled with different types of memory sub-systems 110. FIG. 1 illustrates one example of a host system 105 coupled with one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 105 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 105 uses the memory sub-system 110, for example, to write data to the memory sub-system 110 and read data from the memory sub-system 110.

The host system 105 can be coupled to the memory sub-system 110 using a physical host interface. Examples of a physical host interface include, but are not limited to, a serial advanced technology attachment (SATA) interface, a peripheral component interconnect express (PCIe) interface, universal serial bus (USB) interface, Fiber Channel, a double data rate (DDR) memory bus, Small Computer System Interface (SCSI), Serial Attached SCSI (SAS), a dual in-line memory module (DIMM) interface (e.g., DIMM socket interface that supports DDR), etc. The physical host interface can be used to transmit data between the host system 105 and the memory sub-system 110. The host system 105 can further utilize a non-volatile memory Express (NVMe) interface to access the memory components (e.g., memory device(s) 130) when the memory sub-system 110 is coupled with the host system 105 by the PCIe interface. The physical host interface can provide an interface for passing control, address, data, and other signals between the memory sub-system 110 and the host system 105. FIG. 1 illustrates a memory sub-system 110 as an example. In general, the host system 105 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device(s) 140) can be, but are not limited to, random access memory (RAM), such as dynamic RAM (DRAM) and synchronous DRAM (SDRAM).

Some examples of non-volatile memory devices (e.g., memory device 130) includes a negative-and (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory devices such as 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric RAM (FeRAM), magneto RAM (MRAM), Spin Transfer Torque (SST)-MRAM, conductive bridging RAM (CBRAM), resistive random access memory (RRAM), oxide based RRAM (OxRAM), negative-or (NOR) flash memory, and electrically erasable programmable ROM (EEPROM).

The memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination of such. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), a digital signal processor (DSP)), or other suitable processor.

The memory sub-system controller 115 can include a processor 120 (e.g., a processing device) configured to execute instructions stored in a local memory 125. In the illustrated example, the local memory 125 of the memory sub-system controller 115 includes an embedded memory configured to store instructions for performing various processes, operations, logic flows, and routines that control operation of the memory sub-system 110, including handling communications between the memory sub-system 110 and the host system 105.

In some examples, the local memory 125 can include memory registers storing memory pointers, fetched data, etc. The local memory 125 can also include read-only memory (ROM) for storing micro-code. While the example memory sub-system 110 in FIG. 1 has been illustrated as including the memory sub-system controller 115, in another example of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 105 and can convert the commands or operations into instructions or appropriate commands to achieve the desired access to the memory devices 130 and/or the memory device 140. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 105 via the physical host interface. The host interface circuitry can convert the commands received from the host system into command instructions to access the memory devices 130 and/or the memory device 140 as well as convert responses associated with the memory devices 130 and/or the memory device 140into information for the host system 105.

The memory sub-system 110 can also include additional circuitry or components that are not illustrated. In some examples, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some examples, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

The memory sub-system 110 includes a prefetch manager 150 that can detect a sequential read, detect a low queue depth, and prefetch data from NAND to store in internal performance memory 155 (e.g., SRAM). In some cases, the prefetch manager 150 can determine the sequential read based on determining a size of the data associated with one or more tags in a queue for processing at the memory sub-system 110, based on determining a number of sequential read commands, or both. In some examples, the prefetch manager 150 can detect the low queue depth by determining a number of outstanding commands (e.g., read commands) in the memory sub-system 110.

In some examples, the memory sub-system controller 115 includes at least a portion of the prefetch manager 150. For example, the memory sub-system controller 115 can include a processor 120 (e.g., a processing device) configured to execute instructions stored in local memory 125 for performing the operations described herein. In some examples, the prefetch manager 150 is part of or in communication with the host system 105, an application, or an operating system.

The prefetch manager 150 can detect a command to prefetch data and allocate resources for the command. In some cases, the prefetch manager 150 can detect a write pattern and refrain from prefetching the data based on the detection of the write pattern in the memory sub-system 110 or in a queue of the memory sub-system 110. In such cases, the prefetch manager 150 can flush the prefetch data (e.g., erase prefetched data stored at the internal performance memory 155) based on the detection of the write pattern in the memory sub-system 110. Further details with regards to the operations of the prefetch manager 150 are described below.

FIG. 2 is a flow diagram of an example method 200 to sequential prefetching through a linking array in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some examples, the method 200 is performed by the prefetch manager 150 of FIG. 1. Although shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every example. Other process flows are possible.

At operation 205, the processing device can detect a sequential read. For example, the processing device can detect a set of tags occupying a queue of a memory sub-system (e.g., memory sub-system 110 of FIG. 1). In some cases, the set of tags is associated with a single read descriptor indicating a sequential read pattern for the set of tags. The single read descriptor can be an example of an HTag (e.g., read command) or other command applicable to multiple tags of the set of tags. For example, a single read descriptor can be used for each of the tags within the set of tags, and each tag of the set of tags can be linked to at least one other tag of the set of tags.

A processing device (such as processor 120 of FIG. 1) can determine that an amount of data of the memory sub-system is above a threshold (e.g., an amount of data in a queue of the memory sub-system is above a data threshold). For example, the processing device can determine (e.g., detect) the sequential read based on determining a size of data of the memory sub-system or in a queue of the memory sub-system. In other examples, the processing device can determine that a sequential read of the sequential read pattern is above a sequential read threshold. For example the processing device can determine (e.g., detect) the sequential read based on determining a number of sequential read commands received at the memory sub-system or in a queue of the memory sub-system.

In some cases, the processing device can determine that the number of the set of tags occupying the queue is above the queue threshold. In such cases, the processing device can remove, from an internal performance memory (e.g., internal performance memory 155 of FIG. 1), data associated with a least recently used read stream. For example, if the queues of the memory sub-system are occupied, then the processing device can eject (e.g., remove or erase) data from a least recently used stream. Data corresponding to one of the tags can be stored based on ejecting the data.

The processing device can detect that a second set of tags occupying the queue of the memory sub-system corresponds to a non-sequential read pattern. In such cases, the processing device can remove, from the internal performance memory, data associated with a least recently used read stream. For example, after receiving a number of commands not related to the sequential read, the processing device can eject the data from a least recently used stream. Data corresponding to one of the tags can be stored based on removing (e.g., ejecting the data). In some examples, aspects of the operations of 205 can be performed by prefetch manager 150 as described with reference to FIG. 1

At operation 210, the processing device can detect a low queue depth. For example, the processing device can determine that a number of the set of tags occupying the queue is below a queue threshold. In such cases, the processing device can assign a sequential read of the sequential read pattern to a queue slot of the queue. For example, if the queues of the memory sub-system are unoccupied, then the processing device can assign a sequential read to a queue slot.

The processing device can transmit, to a memory manager (e.g., backend manager), a read request for the data corresponding to at least one of the tags of the set of tags. The processing device can determine that a number of unoccupied queue slots in the queue is above the queue threshold and determine a number of outstanding sequential reads of the sequential read pattern (e.g., based on a number of unoccupied slots of the queue of the memory sub-system). For example, the processing device can determine a number of outstanding commands in the memory sub-system to detect the low queue depth.

In some examples, the processing device can detect that a second set of tags occupying the queue of the memory sub-system corresponds to a write pattern. In such cases, the processing device can refrain from storing the data corresponding to at least one of the tags of the set of tags in the internal performance memory of the memory sub-system. For example, the processing device can detect a write pattern and refraining from prefetching the data based on the detection of the write pattern in the memory sub-system. If a write pattern is detected in the memory sub-system, the processing device can flush, from the internal performance memory, the stored data corresponding to at least one of the tags of the set of tags. In some examples, aspects of the operations of 210 can be performed by prefetch manager 150 as described with reference to FIG. 1

At operation 215, the processing device can prefetch data from NAND to store in internal performance memory such as SRAM. For example, the processing device can store data associated with at least one tag of the set of tags in an internal performance memory of the memory sub-system. The processing device can transmit a read request (e.g., to the NAND or a backend manager of the NAND) and receive a read response associated with the data corresponding to at least the one tag of the set of tags. In such cases, storing the data can be based on receiving the read response such that the read response indicates the read data and the read data is stored on internal performance memory).

In some cases, the processing device can receive a command to retrieve data from a backend of a memory device (e.g., memory manager) and allocate resources of the internal performance memory. In such cases, the data associated with at least the one tag of the set of tags can be stored at the allocated resources of the internal performance memory. For example, the processing device can detect a command to prefetch data and allocate resources for the command. In some examples, aspects of the operations of 215 can be performed by prefetch manager 150 as described with reference to FIG. 1

FIG. 3 is a block diagram of an example system 300 that supports sequential prefetching through a linking array in accordance with some embodiments of the present disclosure. The system 300 can include memory sub-system 305. Memory sub-system 305 can include frontend manager 310, prefetch manager 315, internal performance memory 330, and queue 320. The system 300 can also include host system 335 and memory manager 325.

The memory sub-system 305 can receive, from host system 335, commands for a sequential read operation. The prefetch manager 315 can transmit a read request for data corresponding to a tag of the set of tags to the memory manager 325. The memory manager 325 can be included in the memory sub-system 305 or can be separate from the memory sub-system 305. Based on transmitting the read request, the prefetch manager 315 can receive a read response associated with the data corresponding to a tag of the set of tags. The prefetch manager 315 can store the data in an internal performance memory 330 of the memory sub-system. Storing data in the internal performance memory 330 can enable the prefetch manager 315 to prefetch data when the depth of the queue 320 is low and when a sequential read is detected. Rather than using resources to fetch data every time a read request is received, the prefetch manager 315 can prefetch the data for the sequential reads, thereby decreasing the processing time, overhead, and power consumption.

The tag included in the set of tags can be an example of an internal data description and control blocks that can be used to pass user data information and the data between hardware and firmware components. The processing core configured to receive the tag can be included in the prefetch manager 315 or the memory manager 325. The tag can include a link to another tag in the set of tags. For example, the frontend manager 310 can send a single tag that includes a link (e.g., a next tag identifier can be included in a field of the single tag) to another tag where the information associated with the tags can be stored in the internal performance memory 330 from one processing core to a different processing core. When the memory manager 325 receives the tag, the memory manager 325 can retrieve the data associated with the tag of the set of tags. If the internal performance memory 330 includes the data associated with the tag, the data can be retrieved from the internal performance memory 330.

The linking of tags can allow the prefetch manager 315 to prefetch the data without delaying or negatively affecting the other components (e.g., host system 335, frontend manager 310, and memory manager 325). For example, the prefetch manager 315 can link tags together that are not yet associated with a command from the host system 335. In such case, if the memory sub-system includes a single queue depth environment with sequential reads, the prefetch manager 315 can identify (e.g., anticipate) the read command for the next tag (or LBA) and prefetch the data from the memory manager 325. If the prefetch manager 315 detects a low queue depth and a sequential read, the prefetch manager 315 can prefetch data from the NAND (e.g., memory manager 325) and store in the SRAM (e.g. internal performance memory 330). In such cases, when the host system 335 issues the next read request, the data is already stored in the internal performance memory, and the next read request is not processed by the memory manager 325, thereby decreasing processing times and increasing efficiency.

The prefetch manager 315 can detect that a set of tags occupying queue 320 of the memory sub-system 305 correspond to a single read descriptor (e.g., HTag) which indicates the sequential read. For example, the prefetch manager 315 can detect the number of commands in the memory sub-system 305 that are outstanding. The prefetch manager 315 can store the number of outstanding commands in a table to track the conditions of the queue 320. For example, the prefetch manager 315 can identify, via the table, that the previous command was a read command. In such cases, the prefetch manager 315 can detect a sequential read pattern based on determining that a sequential read of the sequential read pattern is above a sequential read threshold (e.g., determines a number of consecutive read commands exceeds a threshold). In other examples, the prefetch manager 315 can detect a sequential read if the amount of data of the memory sub-system is above (e.g., exceeds) a data threshold.

The prefetch manager 315 can detect the condition of the queue 320 (e.g., a low queue depth). In some cases, the prefetch manager 315 can determine that a number of the set of tags occupying the queue 320 is below a queue threshold (e.g., low). The depth of the queue 320 can be low when the number of tags allocated for the host command from the host system 335 is low. For example, the prefetch manager 315 can determine a number of unoccupied slots in the queue 320. The prefetch manager 315 can detect a low queue depth based on determining that the number of unoccupied slots is above a threshold (e.g., exceeds the queue threshold). In some cases, the prefetch manager 315 can determine a number of outstanding sequential reads of the read pattern after determining the number of unoccupied slots. In some examples, the prefetch manager 315 can assign a sequential read of the sequential read pattern to a slot within queue 320 based on determining that the queue depth is low.

In some cases, the prefetch manager 315 can refrain from storing the data in the internal performance memory 330. For example, the prefetch manager 315 can detect if a write command (e.g., write pattern) is in the memory sub-system 305 or in the queue 320. In such cases, the prefetch manager 315 can detect that a second set of tags occupying the queue 320 correspond to a write pattern. The write pattern and read patterns can utilize separate buffer pools (e.g., internal performance memory 330) such that the prefetch manager 315 would require a separate, empty buffer pools to store data for the write pattern. In some cases, the queue 320 can already be occupied by the read pattern. Therefore, the prefetch manager 315 can refrain from storing the data corresponding to the tag in the internal performance memory 330 of the memory sub-system 305. In other examples, the prefetch manager 315 can flush the stored data corresponding to the tag from the internal performance memory 330 based on detecting a write pattern.

In some cases, the prefetch manager 315 can determine that the number of tags occupying queue 320 is above the queue threshold (e.g., each of the queues is occupied). In such cases, the prefetch manager 315 can remove (e.g., eject) data associated with the least recently used stream from the internal performance memory 330. In other examples, the prefetch manager 315 can detect the second set of tags occupying the queue 320 correspond to a non-sequential read pattern. For example, after the prefetch manager 315 detects a number of commands unrelated to the sequential read (e.g., related to a write pattern, an erase pattern, or the like), the prefetch manager 315 can eject data from the read data stream (e.g., least recently used stream).

The prefetch manager 315 can detect that the host command (e.g. command received from host system 335) requests prefetched data. For example, the prefetch manager 315 can include a coherency checker that detects the host command. For example, when a read command or write command is received at the memory sub-system, the command can be transmitted through the coherency checker to verify if outstanding data in the memory sub-system is related to the received host command. The prefetch data can be placed in the coherency checker with an indicator that identifies the data as prefetched data. The prefetched data can be placed into a buffer. For example, the data associated with the tag can be stored in the internal performance memory 330 of the memory sub-system 305. When the read command is received from the host system 335, the command can be processed by the coherency checker. The coherency checker can identify that the data is already in the internal performance memory 330, thereby preventing the prefetch manager 315 from transmitting a read request to the memory manager 325 (e.g., NAND). In such cases, the data can be directly transferred from the internal performance memory 330.

In some case, the prefetch manager 315 detects a command to retrieve prefetched data from the internal performance memory 330. To retrieve the prefetched data, the prefetch manager 315 can allocate the tags and buffers for a single read descriptor (e.g., HTag). For each command received by the memory sub-system 305, resources can be allocated of the internal performance memory 330. In such cases, the data associated with at least one tag can be stored at the allocated resources of the internal performance memory 330.

FIG. 4 is an example machine of a computer system 400 in which examples of the present disclosure can operate. The computer system 400 can include a set of instructions, for causing the machine to perform any one or more of the techniques described herein. In some examples, the computer system 400 can correspond to a host system (e.g., the host system 105 described with reference to FIG. 1) that includes, is coupled with, or utilizes a memory sub-system (e.g., the memory sub-system 110 described with reference to FIG. 1) or can be used to perform the operations of a controller (e.g., to execute an operating system to perform operations corresponding to the prefetch manager 150 described with reference to FIG. 1). In some examples, the machine can be connected (e.g., networked) with other machines in a local area network (LAN), an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” can also include any collection of machines that individually or jointly execute a set (or multiple sets) of instructions to perform any one or more of the methodologies discussed herein.

The example computer system 400 can include a processing device 405, a main memory 410 (e.g., ROM, flash memory, DRAM such as SDRAM or Rambus DRAM (RDRAM), etc.), a static memory 415 (e.g., flash memory, SRAM, etc.), and a data storage system 425, which communicate with each other via a bus 445.

Processing device 405 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 405 can also be one or more special-purpose processing devices such as an ASIC, an FPGA, a DSP, network processor, or the like. The processing device 405 is configured to execute instructions 435 for performing the operations and steps discussed herein. The computer system 400 can further include a network interface device 420 to communicate over the network 440.

The data storage system 425 can include a machine-readable storage medium 430 (also known as a computer-readable medium) on which is stored one or more sets of instructions 435 or software embodying any one or more of the methodologies or functions described herein. The instructions 435 can also reside, completely or at least partially, within the main memory 410 and/or within the processing device 405 during execution thereof by the computer system 400, the main memory 410 and the processing device 405 also constituting machine-readable storage media. The machine-readable storage medium 430, data storage system 425, and/or main memory 410 can correspond to a memory sub-system.

In one example, the instructions 435 include instructions to implement functionality corresponding to a prefetch manager 450 (e.g., the prefetch manager 150 described with reference to FIG. 1). While the machine-readable storage medium 430 is shown as a single medium, the term “machine-readable storage medium” can include a single medium or multiple media that store the one or more sets of instructions. The term “machine-readable storage medium” can also include any medium that is capable of storing or encoding a set of instructions for execution by the machine and that cause the machine to perform any one or more of the methodologies of the present disclosure. The term “machine-readable storage medium” can include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine (e.g., a computer) readable storage medium such as ROM, RAM, magnetic disk storage media, optical storage media, flash memory components, etc.

In the foregoing specification, examples of the disclosure have been described with reference to specific example examples thereof. It will be evident that various modifications can be made thereto without departing from the broader scope of examples of the disclosure as set forth in the following claims. The specification and drawings are, accordingly, to be regarded in an illustrative sense rather than a restrictive sense.

What is claimed is:

1. A method comprising:
detecting that a set of tags occupying a queue of a memory sub-system corresponds to a single read descriptor indicating a sequential read pattern;
determining that a number of the set of tags occupying the queue is below a queue threshold; and
storing data associated with at least one tag of the set of tags in an internal performance memory of the memory sub-system based at least in part on the detecting and the determining.

2. The method of claim 1, further comprising:
transmitting, to a memory manager, a read request for the data corresponding to at least the one tag of the set of tags based at least in part on the determining; and
receiving a read response associated with the data corresponding to at least the one tag of the set of tags based at least in part transmitting the read request, wherein storing the data is based at least in part on receiving the read response.

3. The method of claim 1, wherein detecting that the set of tags occupying the queue of the memory sub-system corresponds to the sequential read pattern further comprises:
determining that an amount of data of the memory sub-system is above a data threshold.

4. The method of claim 1, wherein detecting that the set of tags occupying the queue of the memory sub-system corresponds to the sequential read pattern:
determining that a sequential read of the sequential read pattern is above a sequential read threshold.

5. The method of claim 1, wherein determining that the number of the set of tags occupying the queue is below the queue threshold further comprises:
determining a number of unoccupied queue slots in the queue is above the queue threshold; and
determining a number of outstanding sequential reads of the sequential read pattern based at least in part on determining the number of unoccupied queue slots.

6. The method of claim 1, further comprising:
receiving a command to retrieve data from a memory manager of a memory device; and
allocating resources of the internal performance memory based at least in part on the receiving, wherein the data associated with at least the one tag of the set of tags is stored at the allocated resources of the internal performance memory.

7. The method of claim 1, further comprising:
detecting that a second set of tags occupying the queue of the memory sub-system corresponds to a write pattern; and
refraining from storing the data corresponding to at least the one tag of the set of tags in the internal performance memory of the memory sub-system.

8. The method of claim 7, further comprising:
flushing, from the internal performance memory, the stored data corresponding to the at least one tag of the set of tags based at least in part on detecting.

9. The method of claim 1, further comprising:
determining that the number of the set of tags occupying the queue is above the queue threshold; and
removing, from the internal performance memory, data associated with a least recently used read stream based at least in part on determining, wherein storing the data corresponding to at least the one tag is based at least in part on the removing.

10. The method of claim 1, further comprising:
detecting that a second set of tags occupying the queue of the memory sub-system corresponds to a non-sequential read pattern; and
removing, from the internal performance memory, data associated with a least recently used read stream based at least in part on determining, wherein storing the data corresponding to at least the one tag is based at least in part on the removing.

11. The method of claim 1, wherein each tag of the set of tags is linked to at least the one tag of the set of tags.

12. The method of claim 1, further comprising:
assigning a sequential read of the sequential read pattern to a queue slot of the queue based at least in part on determining that the number of the set of tags occupying the queue is below the queue threshold.

13. A system comprising:
a plurality of memory components; and
a processing device, operatively coupled with the plurality of memory components, to:
detect that a set of tags occupying a queue of a memory sub-system corresponds to a single read descriptor indicating a sequential read pattern;
determine that a number of the set of tags occupying the queue is below a queue threshold; and
store data corresponding to at least one tag of the set of tags in an internal performance memory of the memory sub-system based at least in part on the detecting and the determining.

14. The system of claim 13, further comprising:
the processing device to:
transmit, to a memory manager, a read request for the data corresponding to at least the one tag of the set of tags based at least in part on the determining; and
receive a read response associated with the data corresponding to at least the one tag of the set of tags based at least in part transmitting the read request, wherein storing the data is based at least in part on receiving the read response.

15. The system of claim 13, further comprising:
the processing device to:
determine that an amount of data of the memory sub-system is above a data threshold, wherein detecting that the set of tags occupying the queue of the memory sub-system corresponds to the sequential read pattern is based at least in part on the determining.

16. The system of claim 13, further comprising:
the processing device to:
determine that a sequential read of the sequential read pattern is above a sequential read threshold, wherein detecting that the set of tags occupying the queue of the memory sub-system corresponds to the sequential read pattern is based at least in part on the determining.

17. The system of claim 13 further comprising:
the processing device to:
determine a number of unoccupied queue slots in the queue is above the queue threshold; and
determine a number of outstanding sequential reads of the sequential read pattern based at least in part on determining the number of unoccupied queue slots.

18. The system of claim 13, further comprising:
the processing device to:
receive a command to retrieve data from a memory manager of a memory device; and
allocate resources of the internal performance memory based at least in part on the receiving, wherein the data associated with at least the one tag of the set of tags is stored at the allocated resources of the internal performance memory.

19. A non-transitory computer-readable storage medium comprising instructions that, when executed by a processing device, cause the processing device to:
detect that a set of tags occupying a queue of a memory sub-system corresponds to a sequential read pattern such that a single read descriptor is associated with the set of tags;
determine that a number of the set of tags occupying the queue is below a queue threshold; and
store data corresponding to at least one tag of the set of tags in an internal performance memory of the memory sub-system based at least in part on detecting and determining.

20. The non-transitory computer-readable storage medium of claim 19, wherein the processing device is further to:
transmit, to a memory manager, a command requesting the data corresponding to at least the one tag of the set of tags based at least in part on determining; and
receive a read response associated with the data corresponding to at least the one tag of the set of tags based at least in part transmitting the command, wherein storing the data is based at least in part on receiving the read response.
